(19) United States
(12) Patent Application Publication
(10) Pub. No.: US 2003/0028014 A1
(43) Pub. Date: Feb. 6, 2003

(54) Agglomerated modified cyclodextrin and process for making same

(76) Inventors: Chris Sikorski, Schererville, IN (US); Wen Shieh, Munster, IN (US)

Correspondence Address: BIERMAN MUSERLIAN AND LUCAS, 600 THIRD AVENUE, NEW YORK, NY, 10016

(21) Appl. No.: 09/843,181

(22) Filed: Apr. 26, 2001

(51) Int. Cl. C08B 37/16

(52) U.S. Cl. 536/103

(57) ABSTRACT

An agglomerated modified cyclodextrin is made in a two drum dryer. The agglomerated product has low dusting problems and good dissolution in water. The particle size of the agglomerated product is 30 to 200 microns.

### BACKGROUND OF INVENTION

1. Technical Field

This invention relates to cyclodextrins and, more particularly, to agglomerated modified cyclodextrin and a process for producing the agglomerated cyclodextrin. The agglomerated cyclodextrin has improved dusting properties and readily dissolves in water.

2. Description of Related Art

Cyclodextrins are macrocyclic polymers of glucose and are conventionally made by treating starch or a liquefied starch with an enzyme, cyclodextrin glycosyltransferase (CGT), at the appropriate temperature, pH, and time for the enzyme. Cyclodextrin polymers of six, seven or eight glucose units are referred to as alpha-, beta- and gamma-cyclodextrins, respectively.

Modified cyclodextrins are made in a reaction between cyclodextrin and a chemical reactant. The degree of substitution of thecyclodextrin by the reactant varies depending on the reaction conditions and the desired results. It is conventional to modify the cyclodextrin to increase its water solubility, especially to make highly soluble derivatives such as hydroxypropylated, methylated, sulfo butyl ether, hydroxyethylated, branched to name a few.

Generally, modified cyclodextrins are prepared in an aqueous reaction wherein the resulting product is dewatered and dried to a powder having a moisture content below 12%. Conventionally, the drying step is conducted in a spray dryer of the type conventionally employed in the starch industry.

A problem of dusting has been found to exist with modified cyclodextrins which have been dried in a spray dryer. Also, it has been found that the spray dried modified cyclodextrin is harder to dissolve in water. For example, hydroxypropylated cyclodextrin is prepared by reacting cyclodextrin with propylene oxide in water and the resulting product is spray dried to a powder. Typically, the powder has a particle size less than 100 microns. This small particle size leads to dusting problems and is hard to dissolve in water, often resulting in clumps. There is a need to solve the dusting and slow dissolution problems associated with dried, modified cyclodextrins.

One solution, for hydroxypropylated beta-cyclodextrin, has been to form a pulverulent hydroxypropylated beta-cyclodextrin composition, see U.S. Pat. No. 5,756,484. The pulverulent product is prepared by spraying an aqueous slurry of hydroxypropylated beta-cyclodextrin onto a moving bed of dried product. Alternatively, the pulverulent product is produced in a special spraying tower. Such special equipment can be costly, and there is a need for a simple, inexpensive method for making a dried modified cyclodextrin which has reduced dusting problems and good dissolution in water properties.

### SUMMARY OF INVENTION

It has been discovered that an agglomerated, modified cyclodextrin can be made in a simple, inexpensive process; and that the agglomerated cyclodextrin has superior dusting properties and dissolution in water properties compared to conventional spray dried modified cyclodextrin.

The product of the present invention has been found to dissolve readily in water in a matter of minutes with minimal stirring and without clumping.

Broadly, the product of the present invention is a dried, agglomerated, modified cyclodextrin product having flake-shaped particles; a particle size distribution wherein about 50% or more by weight of the particles have a particle size greater than about 20 microns and about 90% or more by weight of the particles have a particle size less than about 200 microns; and said particles have a porous structure.

Broadly, the process of the present invention comprises drying an aqueous solution of modified cyclodextrin on a double drum dryer and recovering a dried, agglomerated, modified cyclodextrin product with improved dusting and aqueous dissolution properties wherein the product is characterized as having flake-shaped particles; a particle size distribution wherein about 50% or more by weight of the particles have a particle size greater than about 20 microns and about 90% or more by weight of the particles have a particle size less than about 200 microns; and said particles have a porous structure.

The product of the present invention can be distinguished from the spray dried product based on a number of characteristics. First, the product of the present invention has improved dusting characteristics. Second, the product of the present invention has improved dissolving properties. Third, the product of the present invention has flake-shaped particles while the spray dried product is bead-shaped. Fourth, the product of the present invention is more porous than the spray dried product. Fifth, the product of the present invention has a larger particle size than the spray dried product.

### BRIEF DESCRIPTION OF DRAWINGS

FIG. 1 illustrates a double drum dryer for use in the present invention;

FIGS. 2-5 illustrate the flake-shaped product of the present invention; and

FIG. 6 illustrates the bead-shaped product of the prior art spray dried product.

### DETAILED DESCRIPTION OF INVENTION

The agglomerated, modified cyclodextrin product is made from a modified cyclodextrin. The degree of substitution of the cyclodextrin with the reactant group does not matter, thus, it can vary according to the product resulting from the modification reaction. Also, the modified cyclodextrin which is subject to the process of the present invention can be uniform or homogeneous in degrees of substitution or it can be random and varied. The modification reaction is conducted in a conventional way using conventional equipment. The present invention has been found to be especially advantageous for hydroxypropylated cyclodextrin.

The cyclodextrin used to make the modified cyclodextrin is any type of unmodified cyclodextrin or mixtures of unmodified cyclodextrins. Suitable cyclodextrins include unmodified alpha-, beta- and gamma-cyclodextrins as well as branched cyclodextrins. Branched cyclodextrins have one or more glucose moieties emanating from the torus structure of the cyclodextrin. Good results have been obtained with hydroxypropylated beta-cyclodextrin.

The aqueous solution of modified cyclodextrin which is used to make the product of the present invention has a solids content of about 45% or more by weight of solution and good results have been obtained with solids contents of about 55% or more by weight of solution. Typically, the aqueous solution resulting from the modification reaction has a solids content of about 5 to about 70% by weight solution. Before the slurry is subject to the drying step in accordance with the present invention, it is dewatered in a conventional manner using conventional equipment to obtain a solution having a solids content of about 45% by weight or above.

The aqueous solution of modified cyclodextrin which is used to make the product of the present invention can also be made by forming an aqueous solution of dried, modified cyclodextrin. For example, a spray dried, modified cyclodextrin can be slurried with water and the resulting slurry dried in accordance with the present invention to produce the dried, agglomerated, modified cyclodextrin of the present invention.

The slurry of modified cyclodextrin comprises uncomplexed, modified cyclodextrin and water. It can also contain normal amounts of residual reaction by-products and residual cyclodextrin. Prior to the drying step of the present invention, the solution can be subject to various purification step(s) to remove residual cyclodextrin and by-products and obtain a substantially pure solution of modified cyclodextrin. The purity of the solution will depend on the intended use of the dried product. Generally, dried product intended for pharmaceutical use has a higher purity than a modified cyclodextrin intended for general industrial use, for example, in a laundry detergent.

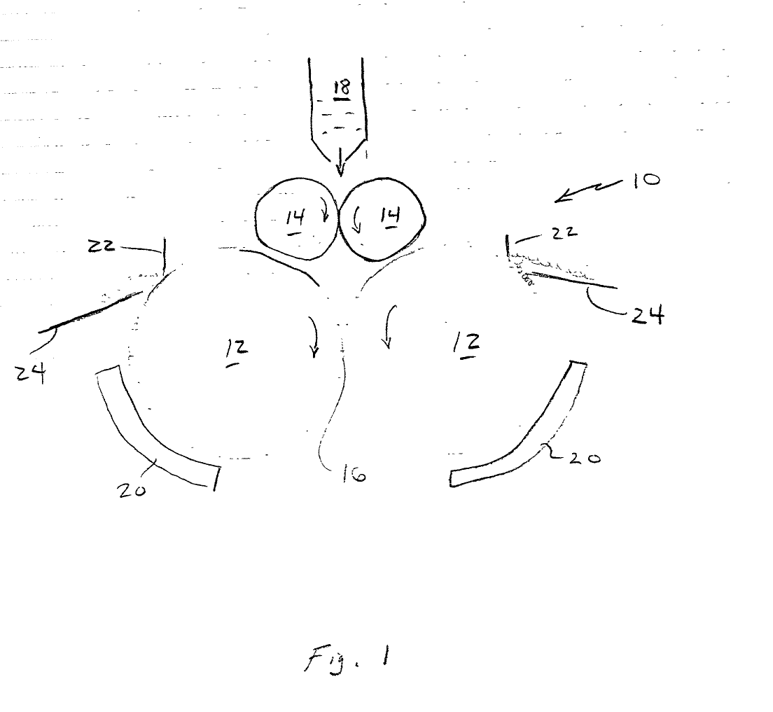

The drying step of the present invention is preferably conducted on a drum dryer and, specifically, a double-drum dryer of the type shown in FIG. 1. Double-drum dryers are conventional pieces of equipment normally used in the starch industry for drying starch.

Turning to FIG. 1, double-drum dryer 10 comprises two opposed rotating drums 12, the righthand drum rotates counter-clockwise while the lefthand drum rotates clockwise. Applicator rollers 14 are placed above nip 16 between drums 12 and the solution of modified cyclodextrin 18 passes between applicator rollers 14 and down into nip 16. Steam is injected into drums 12 to heat the walls of the drums and provide the heat to dry solution 18 as it comes in contact with drums 12. Optionally, exterior heaters 20 can be employed.

The dried product as it passes through nip 16 is agglomerated and sticks to the wall of the respective drums 12. Scrapper blades 22 remove the dried product from the exterior of drums 22 and dried product passes onto platform 24.

The speed at which drums 12 rotate have an effect on the dried product. Suitably, drums 12 are rotated at about 1 to about 5 revolutions per minute (rpm). Good results have been obtained at both 1 and 5 rpms.

The amount of steam injected into the drums is such that the product is dried by the time it reaches scrapper blades 22. The product is suitably dried to a moisture content equal to or less than about 12% and, more preferably, to a moisture content equal to or less than about 5% by weight. Moisture content is determined in a conventional manner.

The amount of steam provided to the drums is conventional. Good results have been obtained using steam at 100 psig.

The product of the present invention is a dried agglomerated modified cyclodextrin which has particles in a size of up to about 200 microns. More specifically, the product of the present invention preferably has about 90% or more by weight of the particles with a particle size less than or equal to about 200 microns.

It is also preferred that the product of the present invention have about 50% or more by weight of the particles with a particle size greater than or equal to about 20 microns and, more preferably, about 30 microns.

More specifically, the agglomerated product has a particle size distribution wherein equal to or greater than about 50% by weight of the particles have a particle size equal to or greater than about 20 microns (μm), and equal to or greater than about 90% by weight of the particles have a particle size equal to or less than 200 microns. Good results have been obtained when the particle size distribution is about 50% or more by weight are greater about 30 microns or more and about 90% or more by weight are 200 microns or less. Particle size is an averaged measurement, determined by the dimension of the dried product and is done in a conventional manner using conventional equipment. Suitably, equipment such as a SYMPATEC particle sizer that determines particle size by a light scattering technique is used.

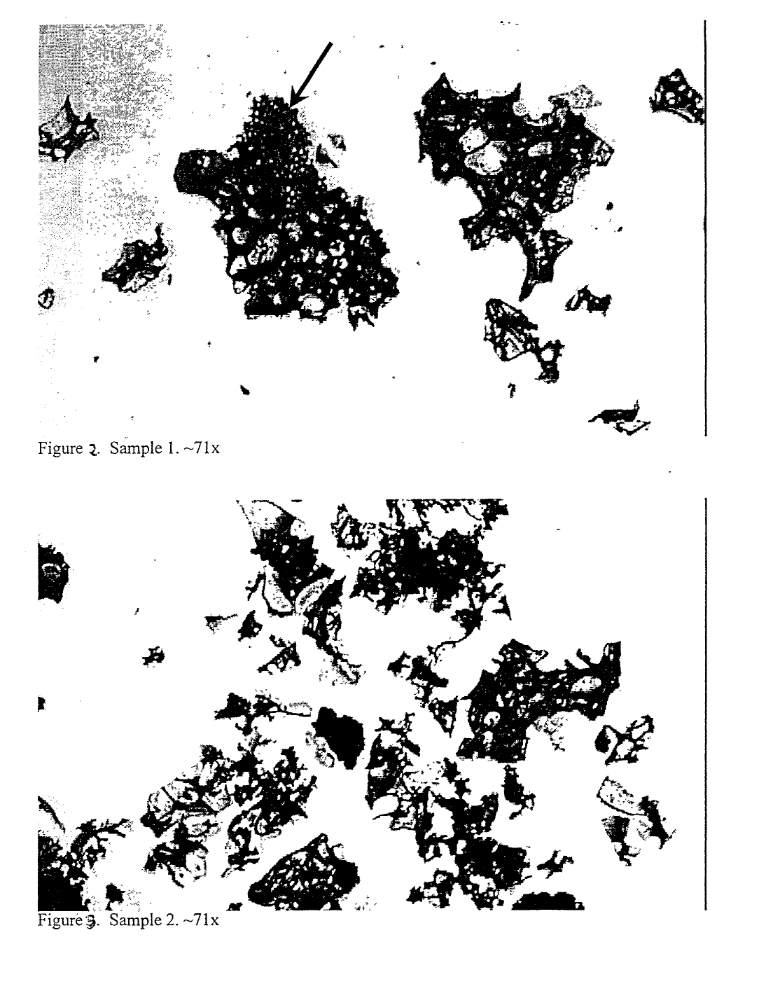

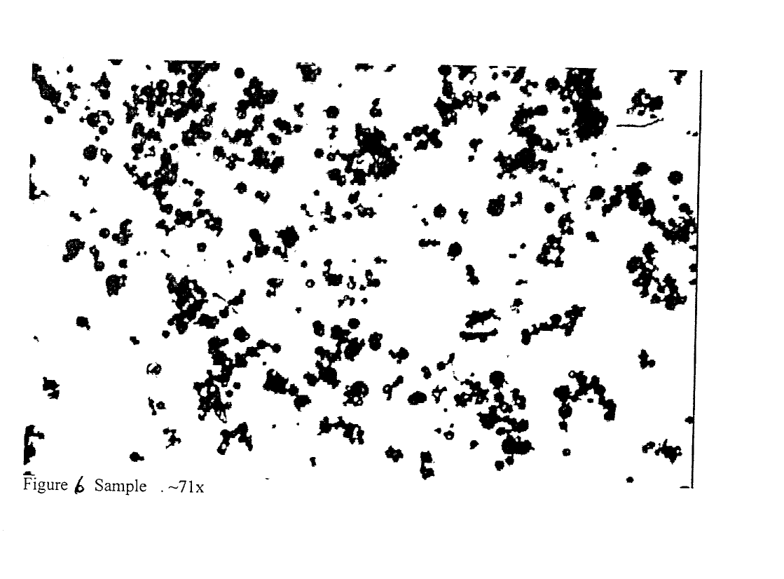

The product of the present invention has a particle shape of a flake rather than a bead. FIGS. 2-5 illustrate the flake-shaped product of the present invention while FIG. 6 illustrates the bead-shaped product of a spray dried modified cyclodextrin.

The product of the present invention is also porous in nature as shown in FIGS. 2-5. The porous structure of the present invention is different than the non-porous structure of the bead-shaped product of FIG. 6 (spray dried product).

The agglomerated, dried modified cyclodextrin having the particle size distribution recited herein has been found to provide low dust and to provide good aqueous dissolution. Specifically, the product of the present invention has been found to dissolve in water in less than about 5 minutes when the water has a temperature of 75° F. (24° C.) and the amount of dried product dissolved in 10% by weight of the solution. Such dissolution is conducted with mild agitation.

Also, because of the size of the agglomerate, dusting is substantially reduced.

Other means of agglomeration can be employed to make the product of the present invention, although the double-drum dryer is preferred. For example, conventional spray dried modified cyclodextrin can be agglomerated in a drum agglomerator. A conventional drum agglomerator comprises an inclined rotary drum where dry product is fed in at one end and agglomerated product is removed from the other end. Normally, a nuclei of material is formed and this can be done by moistening the material before it enters the drum. Blades are used to remove product from the inside walls of the drum. Agglomeration occurs because of the tumbling action of the product in the drum.

These and other aspects of the present invention may be more fully understood by reference to one or more of the following examples.

### EXAMPLE 1

This example illustrates the method of the present invention.

A hydroxypropyl beta-cyclodextrin containing 55% total solids was gradually introduced onto the applicator rolls of a roll dryer of the type shown in FIG. 1. The dryer was operated at the following conditions:

1 rpm on the drying roll

100 psig steam on the drying roll

2 valley feed

no cooling water on applicator roll

The dried product was continuously recovered during the drying process by a scrapping blade held at a fixed position above the drying roll as shown in FIG. 1.

The dried product had a particle size distribution as shown in the Table in Example 5.

### EXAMPLE 2

Example 1 was repeated but the dryer drums were rotated at 5 rpms.

The dried product had a particle size distribution as shown in the Table in Example 5.

### EXAMPLE 3

Example 1 was repeated for a solution having a solids level of 64% by weight.

The dried product had a particle size distribution as shown in the Table in Example 5.

### EXAMPLE 4

Example 1 was repeated except that the dryer drums were rotated at 5 rpms and the solution had a solids content of 64% by weight.

The dried product had a particle size distribution as shown in the Table of Example 5.

### EXAMPLE 5

This example compares the particle size distribution and the dissolution rates of the products of Examples 1-4 which were made in accordance with the present invention and product made by a conventional spray drying technique.

The spray dried hydroxypropyl beta-cyclodextrin was obtained by subjecting a solution (˜25% total solids) to spray drying using a standard spraying tower. The inlet temperature during the drying operation was between 200 and 220° C., and the outlet temperature was between 95 and 105° C.

Particle Size Distribution and Dissolution Data for Examples 1-5

| | | | | Dissolution rate (min) |
|---|---|---|---|---|
| | X10 | X50 | X90 | for 10% solids at 24° C. |
| Spray Dried | 3.74 | 14.12 | 29.72 | 15.33 |
| 55% solids, 1 rpm | 7.14 | 34.88 | 111.46 | 2.75 |
| 55% solids, 5 rpm | 6.02 | 30.22 | 103.30 | 1.5 |
| 64% solids, 1 rpm | 9.75 | 56.54 | 180.85 | 3.5 |
| 64% solids, 5 rpm | 7.29 | 35.62 | 115.98 | 5.5 |

X10: 10% of particles are smaller than . . .
X50: 50% of particles are smaller than . . .
X90: 90% of particles are smaller than . . .
Results are expressed in microns (10⁻⁶ meters)

As can be seen, the dried agglomerated product of the present invention had a substantial number of particles (50%) were larger than 30 microns while the substantial number of spray dried particles (90%) were smaller than 30 microns.

Also, as can be seen, the dissolution time of the dried product was about three to ten times faster than the spray dried product.

It was also observed that the dusting problem of dried product was virtually eliminated with the product of the present invention.

### EXAMPLE 6

This example illustrates the porosity and the shape of the product of the present invention compared to a spray dried product.

The five products as listed in Example 5 above were tested. The samples taken from each product were identified as follows:

| Sample 1 | Product Example 5 |
|---|---|
| 1 | 64% solids, 1 rpm |
| 2 | 64% solids, 5 rpm |
| 3 | 55% solids, 1 rpm |
| 4 | 55% solids, 5 rpm |
| 5 | spray dried |

Each of these products were viewed with a stereo microscope. Each of the powders were viewed without any further preparation. Pictures, micrographs, were taken and are illustrated in FIGS. 2-6.

Samples 1-4 were the present invention and illustrate the flake-shape present invention and are shown in FIGS. 2-5. Sample 5, the spray dried product, was bead-like with most beads being independent of the others.

FIG. 2 illustrates Sample 1 above. Porosity was highly variable. Largest pores were in excess of 300 μm, while the smallest pores were about 10-15 micrometers. Although highly variable, this sample also had the smallest pore size of all the observed samples.

FIG. 3 illustrates Sample 2. This and all subsequent samples were lacking the very small pored particles described for Sample 1. Other than this difference, the pore size for this sample was similar to Sample 1. Average particle size was smaller than Sample 1.

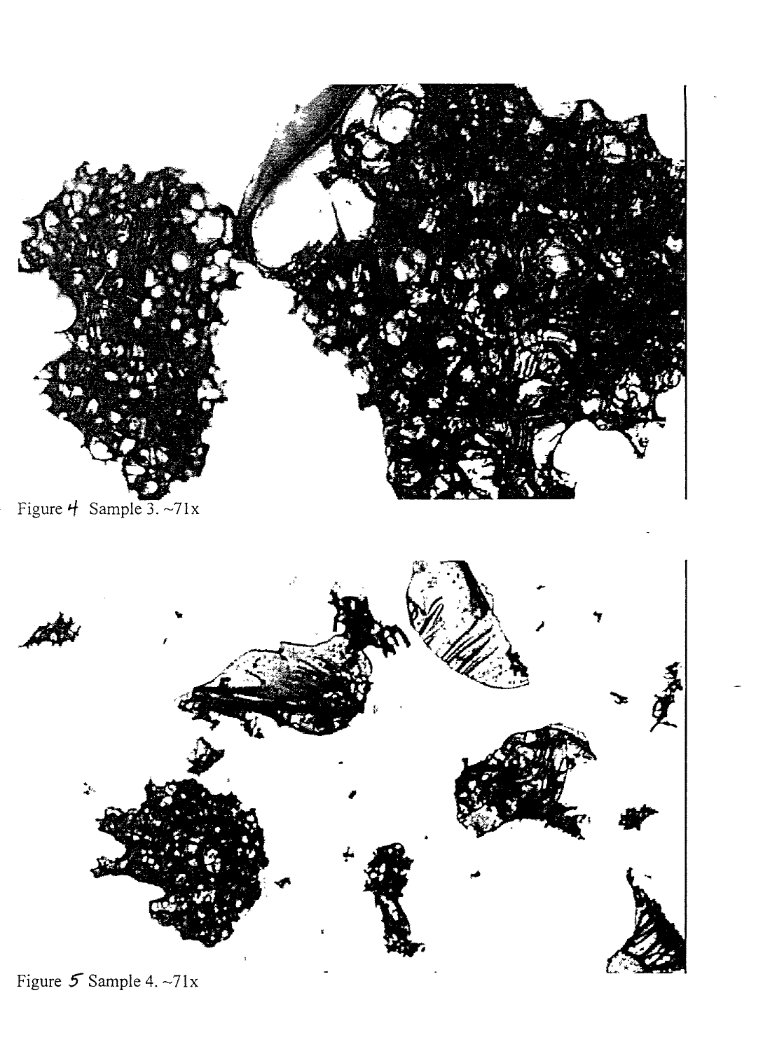

FIG. 4 illustrates Sample 3. These were very large particles on the average, the largest of all the observed samples. Pore sizes were similar to Sample 2, except that the pores at the large end of the scale were the largest observed of all the samples.

FIG. 5 illustrates Sample 4. Particle size was similar to Sample 1. Pore size was similar to Sample 2.

FIG. 6 illustrates Sample 5. Beads are, for the most part, independent of each other, tending not to cluster.

It will be understood that the claims are intended to cover all changes and modifications of the preferred embodiments of the invention herein chosen for the purpose of illustration which do not constitute a departure from the spirit and scope of the invention.

What is claimed is:

1. A process for making a dried modified cyclodextrin product with improved dusting and aqueous dissolution properties comprising drying an aqueous solution of modified cyclodextrin on a double-drum dryer; and
recovering a dried modified cyclodextrin product with improved dusting and aqueous dissolution properties.

2. The process of claim 1 wherein said cyclodextrin is a hydroxypropylated beta-cyclodextrin.

3. The process of claim 1 wherein said drum dryer has steam-heated drums rotated at about 1 to about 5 revolutions per minute.

4. The process of claim 3 wherein said drums are heated with steam at a pressure of about 100 psig.

5. The process of claim 1 wherein about 90% or more by weight of dried product has a particle size of less than or equal to about 200 microns, and about 50% or more by weight of said product has a particle size greater than or equal to about 20 microns.

6. The method of claim 1 wherein said aqueous solution has a solids content of greater than or equal to about 45% by weight.

7. A process for making a dried agglomerated modified cyclodextrin product comprising
drying an aqueous solution of modified cyclodextrin on a double-drum dryer; and
recovering a dried agglomerated modified cyclodextrin product having a particle distribution of about 90% or more by weight less than or equal to 200 microns and about 50% or more by weight greater than or equal to 20 microns.

8. The process of claim 1 wherein said cyclodextrin is a hydroxypropylated beta-cyclodextrin.

9. The process of claim 1 wherein said drum dryer has steam-heated drums rotated at about 1 to about 5 revolutions per minute.

10. The process of claim 3 wherein said drums are heated with steam at a pressure of about 100 psig.

11. The method of claim 1 wherein said aqueous solution has a solids content of greater than or equal to about 45% by weight.

12. A dried agglomerated modified cyclodextrin product having about 90% or more by weight of said product with a particle size of less than or equal to about 200 microns; and about 50% or more by weight of said product with a particle size of greater than or equal to about 20 microns.

13. The product of claim 12 wherein said product has a dissolution time in water of less than about 5 minutes at 75° F. and 10% solids.

14. The product of claim 12 wherein said product is made by a process comprising
drying an aqueous solution of modified cyclodextrin on a drum dryer; and
recovering a dried modified cyclodextrin product having said particle sizes.

15. The product of claim 12 wherein said cyclodextrin is a beta-cyclodextrin.

16. The product of claim 14 wherein said drum dryer has steam-heated drums rotated at about 1 to about 5 revolutions per minute.

17. The product of claim 16 wherein said drums are heated with steam at a pressure of about 100 psig.

18. The product of claim 14 wherein said aqueous solution has a solids content of greater than or equal to about 45% by weight.
